(19) United States
(12) Patent Application Publication
(10) Pub. No.: US 2020/0264820 A1
(43) Pub. Date: Aug. 20, 2020

(54) INFORMATION PROCESSING APPARATUS

(71) Applicant: Tomohide TAKANO, Kanagawa (JP)

(72) Inventor: Tomohide TAKANO, Kanagawa (JP)

(21) Appl. No.: 16/733,272

(22) Filed: Jan. 3, 2020

(30) Foreign Application Priority Data
Feb. 15, 2019 (JP) 2019-025507

(51) Int. Cl. G06F 3/12; H04L 29/06

(52) U.S. Cl. CPC G06F 3/1236; H04L 63/108; H04L 63/0846; G06F 3/1222

(57) ABSTRACT

An information processing apparatus receives a request using unique second identification information that is associated one-to-one with first identification information for identifying a user of a resource and returns third identification information to be used temporarily indicating a transfer destination of the request, in response to the request.

### CROSS-REFERENCE TO RELATED APPLICATIONS

This patent application is based on and claims priority pursuant to 35 U.S.C. § 119(a) to Japanese Patent Application No. 2019-025507, filed on Feb. 15, 2019, in the Japan Patent Office, the entire disclosure of which is hereby incorporated by reference herein.

### BACKGROUND

### Technical Field

The present disclosure relates to an information processing apparatus.

Discussion of the Background Art A guest account (an example of first identification information) is used to allow a guest user to use network resources (for example, printers) in a restricted intranet environment using user's own computer. By limiting the network resources that can be used by the guest account, it is possible to allow the guest user to use the network resources while ensuring the security in the intranet.

The guest user can also access the target network resource without installing a driver on the user's computer, by accessing a uniform resource locator (URL) that provides a web user interface (UI) corresponding to the target network resource from a web browser.

### SUMMARY

Embodiments of the present disclosure describe an information processing apparatus. The information processing apparatus receives a request using unique second identification information that is associated one-to-one with first identification information for identifying a user of a resource and returns third identification information to be used temporarily indicating a transfer destination of the request, in response to the request.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a block diagram illustrating a configuration of an information processing system according to embodiments of the present disclosure;

FIG. 2 is a diagram of a hardware configuration of a liquid discharging device (inkjet printer) according to embodiments of the present disclosure;

FIG. 3 is a diagram of a hardware configuration of a personal computer (PC) (server) according to embodiments of the present disclosure;

FIG. 4 is a diagram of a hardware configuration of a multifunction peripheral (MFP) according to embodiments of the present disclosure;

FIG. 5 is a block diagram illustrating a functional configuration of a print server according to embodiments of the present disclosure;

FIG. 6 is a sequence diagram illustrating a basic redirect process executed by the information processing system;

FIG. 7 is a sequence diagram illustrating an example of a process when an invalid temporary URL is accessed;

FIG. 8 is a flowchart illustrating an example of a series of processes executed by the print server related to URL determination; and

FIGS. 9A to 9C are flowcharts illustrating an example of temporary URL deletion process (or update process).

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise.

Hereinafter, the present disclosure is described in detail with reference to embodiments illustrated in the drawings. The components, types, combinations, shapes, relative arrangements, and the like described in the embodiments are merely illustrative examples and not intended to limit the scope of the present disclosure unless otherwise indicated.

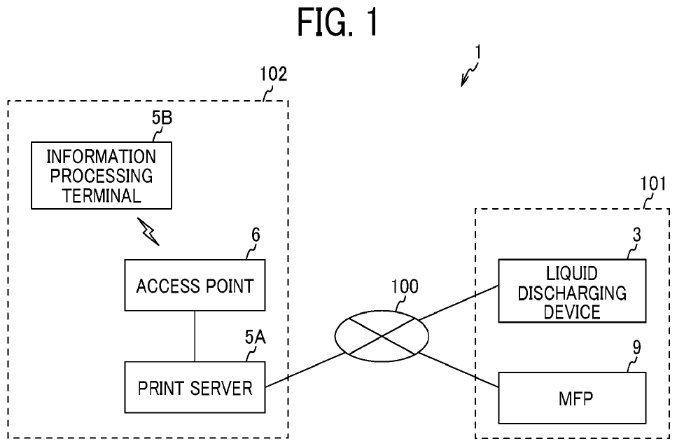

FIG. 1 is a block diagram illustrating a configuration of an information processing system according to the present embodiment.

The information processing system 1 has a configuration in which a first network environment 101 and a second network environment 102 are connected through a communication network 100.

The first network environment 101 is based on, for example, an intranet, and includes a liquid discharging device (inkjet printer) 3 and an MFP 9 as network resources. The liquid discharging device 3 is an image processing device having an image printing function. The MFP 9 is an image processing device having a plurality of image forming functions such as print, copy, scan, and facsimile. The liquid discharging device 3 and the MFP 9 are examples of job processing devices that execute and process a print job.

The second network environment 102 is, for example, a “bring your own device (BYOD)” network environment, and includes a print server 5A, an information processing terminal 5B, and an access point 6.

The print server 5A restricts the connection path of the information processing terminal 5B. That is, connection to devices other than the network resource among the devices included in the first network environment 101 is limited. The print server 5A provides the information processing terminal 5B with a web UI for using the network resources. The web UI provided by the print server 5A enables the information processing terminal 5B to use each network resource without installing a driver corresponding to each network resource.

The information processing terminal 5B is an information processing device such as a smartphone, a tablet terminal, or a personal computer (PC) owned by a guest user. The information processing terminal 5B includes a web browser capable of displaying the web UI provided by the print server 5A, and the information processing terminal 5B outputs data to be printed by the liquid discharging device 3 or the MFP 9 to the print server 5A through the web UI.

The access point 6 is a connection device for connecting a wireless local area network (LAN) device such as the information processing terminal 5B to the print server 5A and the communication network 100 through the print server 5A so as to enable data communication.

Devices included in the information processing system 1 are not limited to the devices described above and any device equipped with communication function may be included in the information processing system 1. The devices included in the information processing system 1 may be, for example, an output device such as a projector (PJ), an interactive white board (an electronic whiteboard with mutual communication capability (IWB)), a digital signage, a heads up display (HUD), and an industrial machine, an imaging device, a sound collecting device, a medical device, a network home appliance, an automobile (connected car), a notebook PC, a mobile phone, a smartphone, a tablet terminal, a game console, a personal digital assistant (PDA), a digital camera, a wearable PC or a desktop PC.

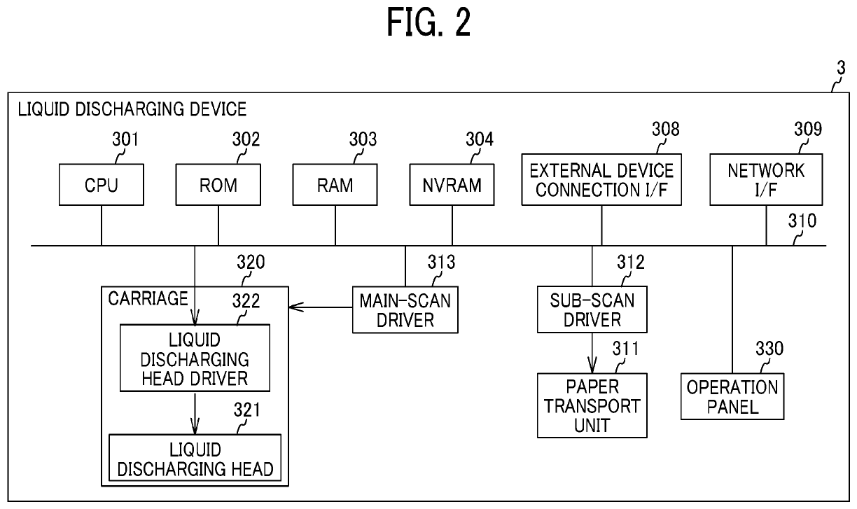

FIG. 2 is a hardware configuration diagram of a liquid discharging device (inkjet printer). As illustrated in FIG. 2, the liquid discharging device 3 includes a central processing unit (CPU) 301, a read only memory (ROM) 302, a random access memory (RAM) 303, a non-volatile random access memory (NVRAM) 304, an external device connection interface (I/F) 308, a network I/F 309, and a data bus 310. In addition, the liquid discharging device 3 includes a paper transport unit 311, a sub-scan driver 312, a main-scan driver 313, a carriage 320, and an operation panel 330. Further, the carriage 320 includes a liquid discharging head 321 and a liquid discharging head driver 322.

The CPU 301 controls an entire operation of the liquid discharging device 3. The ROM 302 stores programs such as an initial program loader (IPL) to boot the CPU 301. The RAM 303 is used as a work area for the CPU 301. The non-volatile random access memory (NVRAM) 304 stores various data such as a program and retains the various data even when the power of the liquid discharging device 3 is shut off. The external device connection I/F 308 is connected to a PC through a universal serial bus (USB) cable or the like and communicates control signals and data to be printed to the PC. The network I/F 309 is an interface for performing data communication using the communication network 100 such as the internet. The data bus 310 is an address bus, a data bus, or the like for electrically connecting each component such as the CPU 301.

The paper transport unit 311 is, for example, a roller and a motor that drives the roller and transports print paper in the sub-scanning direction along transport path in the liquid discharging device 3. The sub-scan driver 312 controls the movement of the paper transport unit 311 in the sub-scanning direction. The main-scan driver 313 controls the movement of the carriage 320 in the main scanning direction.

The liquid discharging head 321 of the carriage 320 has a plurality of nozzles for ejecting liquid such as ink and is mounted on the carriage 320 such that ejection surface (nozzle surface) faces the printing paper side. The liquid discharging head 321 forms an image by ejecting liquid on the printing paper that is intermittently conveyed in the sub-scanning direction while moving in the main-scanning direction. The liquid discharging head driver 322 is a driver for controlling the drive of the liquid discharging head 321.

The operation panel 330 includes a touch panel, an alarm lamp, and the like that display current setting values, selection screens, and the like and receive inputs from the operator.

The liquid discharging head driver 322 may not be included in the carriage 320 but may be connected to the bus line outside the carriage 320. Further, the main-scan driver 313, the sub-scan driver 312 and the liquid discharging head driver 322 may each have a function implemented by a command from the CPU 301 according to a program.

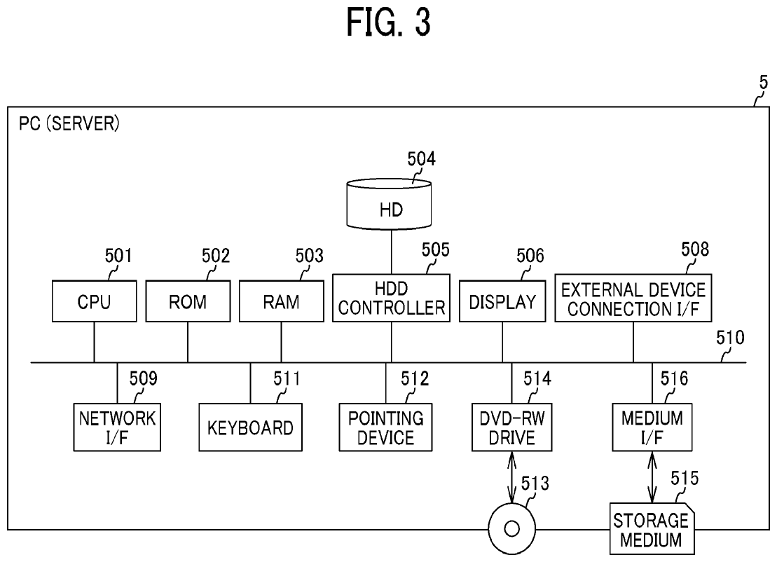

FIG. 3 is a hardware configuration diagram of the PC (server). Here, the hardware configuration of the print server 5A is described.

As illustrated in FIG. 3, the server 5 is implemented by a computer and includes a CPU 501, a ROM 502, a RAM 503, a hard disk (HD) 504, a hard disk drive (HDD) controller 505, a display 506, an external device connection I/F 508, a network I/F 509, a data bus 510, a keyboard 511, a pointing device 512, a digital versatile disk-rewritable (DVD-RW) drive 514, and a medium IN 516.

The CPU 501 controls entire operation of the server 5. The ROM 502 stores a control program such as an IPL to boot the CPU 501. The RAM 503 is used as a work area for the CPU 501. The HD 504 stores various data such as a control program. The HDD controller 505 controls reading and writing of various data from and to the HD 504 under control of the CPU 501. The display 506 displays various information such as a cursor, menu, window, character, or image. The external device connection I/F 508 is an interface for connecting various external devices. The external device in this case is, for example, a USB memory or a printer. The network I/F 509 is an interface for performing data communication using the communication network 100. The data bus 510 is an address bus, a data bus, or the like for electrically connecting each component such as the CPU 501 illustrated in FIG. 3.

The keyboard 511 is an example of input device provided with a plurality of keys for allowing a user to input characters, numerals, or various instructions. The pointing device 512 is an example of an input device that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading and writing (storing) of data from and to the storage medium 515 such as a flash memory.

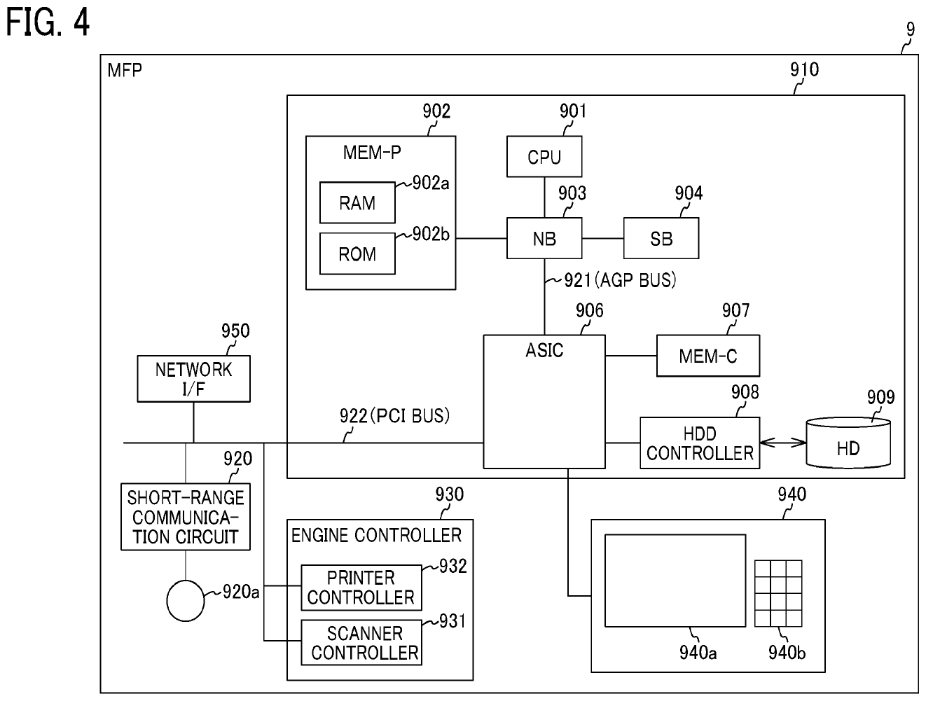

FIG. 4 is a block diagram illustrating a hardware configuration of the MFP. As illustrated in FIG. 4, the MFP 9 includes a controller 910, a short-range communication circuit 920, an engine controller 930, a control panel 940, and a network I/F 950.

The controller 910 includes a CPU 901 as a main processor, a system memory (MEM-P) 902, a north bridge (NB) 903, a south bridge (SB) 904, an Application Specific Integrated Circuit (ASIC) 906, a local memory (MEM-C) 907 as a storage unit, an HDD controller 908, and an HD 909 as a storage unit. The NB 903 and the ASIC 906 are connected through an Accelerated Graphics Port (AGP) bus 921.

The CPU 901 is a processor that performs overall control of the MFP 9. The NB 903 connects the CPU 901 with the MEM-P 902, SB 904, and AGP bus 921. The NB 903 includes a memory controller for controlling reading or writing of various data with respect to the MEM-P 902, a Peripheral Component Interconnect (PCI) master, and an AGP target.

The MEM-P 902 includes a ROM 902b as a memory that stores program and data for implementing various functions of the controller 910. The MEM-P 902 further includes a RAM 902a as a memory that deploys the program and data, or as a drawing memory that stores drawing data for printing. The program stored in the ROM 902b may be stored in any computer-readable storage medium, such as a compact disc-read only memory (CD-ROM), compact disc-recordable (CD-R), or digital versatile disc (DVD), in a file format installable or executable by the computer, for distribution.

The SB 904 connects the NB 903 with a peripheral component interconnect (PCI) device or a peripheral device. The ASIC 906 is an integrated circuit (IC) dedicated to an image processing use, and connects the AGP bus 921, a PCI bus 922, the HDD controller 908, and the MEM-C 907. The ASIC 906 includes a PCI target, an AGP master, an arbiter (ARB) as a central processor of the ASIC 906, a memory controller for controlling the MEM-C 907, a plurality of direct memory access controllers (DMACs) capable of converting coordinates of image data with a hardware logic, and a PCI unit that transfers data between a scanner controller 931 and a printer controller 932 through the PCI bus 922. The ASIC 906 may be connected to a USB interface, or the Institute of Electrical and Electronics Engineers 1394 (IEEE1394) interface.

The MEM-C 907 is a local memory used as a buffer for image data to be copied or code image. The HD 909 is a storage for storing image data, font data used during printing, and forms. The HDD controller 908 reads or writes various data from or to the HD 909 under control of the CPU 901. The AGP bus 921 is a bus interface for a graphics accelerator card, which has been proposed to accelerate graphics processing. Through directly accessing the MEM-P 902 by high-throughput, speed of the graphics accelerator card is improved.

The short-range communication circuit 920 is provided with a short-range communication antenna 920a. The short-range communication circuit 920 is a communication circuit that communicates in compliance with the near field communication (NFC), the Bluetooth (registered trademark) and the like.

The engine controller 930 includes a scanner controller 931 and a printer controller 932. The control panel 940 includes a panel display 940a and operation panel 940b. The panel display 940a is implemented by, for example, a touch panel that displays current settings or a selection screen and receives a user input. The operation panel 940b includes a numeric keypad that receives set values of various image forming parameters such as image density parameter and a start key that accepts an instruction for starting copying. The controller 910 controls entire operation of the MFP 9. For example, the controller 910 controls drawing, communication, or user inputs to the control panel 940. The scanner controller 931 and the printer controller 932 each performs various image processing, such as error diffusion or gamma conversion.

In response to an instruction to select a specific application through the control panel 940, for example, using a mode switch key, the MFP 9 selectively performs a document box function, a copy function, a print function, and a facsimile function. When the document box function is selected, the MFP 9 operates in a document box mode to store document data. With selection of the copy function, the MFP 9 operates in a copy mode. With selection of the print function, the MFP 9 operates in a print mode. With selection of the facsimile function, the MFP 9 operates in a facsimile mode.

The network I/F 950 controls communication of data with an external device through the communication network 100. The short-range communication circuit 920 and the network I/F 950 are electrically connected to the ASIC 906 through the PCI bus 922.

In the present embodiment, a guest user who is a temporary user of network resources is redirected (transferred) to another page (temporary URL 3) corresponding to user identifier (ID) 1 that is a guest account, in response to accessing a dedicated URL 2 associated one-to-one with the user ID 1. The temporary URL 3 indicating the redirect destination in this case is a temporary URL. In addition, when the guest user accesses an invalid temporary URL 3, the guest user is redirected to another page (URL 4).

In the following description, the user ID for a guest is “user ID 1” (first identification information), a URL dedicated to the user ID 1 is “dedicated URL 2” (second identification information), a URL temporarily generated corresponding to the dedicated URL 2 is “temporary URL 3 (3a, 3b, . . . )” (third identification information), and a URL of a user ID selection screen page is “ID selection URL 4” (fourth identification information).

For example, the following can be used as the user ID and the value of each URL corresponding to the user ID.
ID1: g601 URL 2: http://xxx.xxx.xxx.xxx/upload/g601
URL 3a: http://xxx.xxx.xxx.xxx/upload/g601? key=1234
URL 3b: http://xxx.xxx.xxx.xxx/upload/g601? key=5678
URL 4: http://xxx.xxx.xxx.xxx/upload/

The user ID 1 is information for identifying a user of a network resource such as the MFP 9 and indicates a right to use the network resource. When the user uses resources on the first network environment 101 from the second network environment 102, the user is provided with a user ID 1 that is an account for a guest. For example, the user is provided with an ID card having the user ID 1 and the dedicated URL 2 printed thereon. In an integrated circuit (IC) chip embedded in the ID card, information related to the user ID 1 is recorded by a format that can be read by a device included in the information processing system 1.

The dedicated URL 2 is a unique (fixed) URL associated with the user ID 1 on a one-to-one basis, but the page indicated by the dedicated URL 2 is an empty page with no substance. The dedicated URL 2 functions as an entry point to the temporary URL 3.

The temporary URL 3 is information indicating an actual web page associated with the user ID 1 indicating a redirect destination (transfer destination) of a page request for the dedicated URL 2. The temporary URL 3 is a temporary (time-limited or temporarily usable) URL at which access to a real web page is disabled at preset timing.

For example, the temporary URL 3 is generated when the use of the service using the user ID 1 is started and is invalidated by being deleted (or updated) at the preset timing. The preset timing is, for example, when processing of a job created on the web UI page indicated by the temporary URL 3 is completed, or when the session between the print server 5A and the information processing terminal 5B through the web UI is disconnected.

Keys indicated in URL 3a and URL 3b are values updated at the preset timing. The key is updated, for example, every certain time (e.g. every 2 hours), at regular time (e.g. midnight), when a particular event (for example, completion of the above job) occurs, after a certain amount of time has passed since a particular event occurred, or every time a session between the print server 5A and the information processing terminal 5B through the web UI is updated.

The key is preferably a unique value that cannot be easily guessed. For example, the key can be generated using a specific character string, time when the dedicated URL 2 is accessed or date and time information indicating the generation time of the URL 3, a hash value obtained by applying a hash function to date and time information, or the like. By using a unique key, the URL 3 becomes a unique address as a whole. By using a key that is not easily guessed, the URL 3 becomes an address that cannot be easily guessed as a whole.

URL 4 is a URL indicating a redirect destination (transfer destination) when a page request is made for invalid (or nonexistent) temporary URL 3. For example, URL 4 is information for causing the information processing terminal 5B to display a selection screen for allowing the user to select a user ID (or a dedicated URL 2 through the user ID). The page indicated by URL 4 is not limited to the above description.

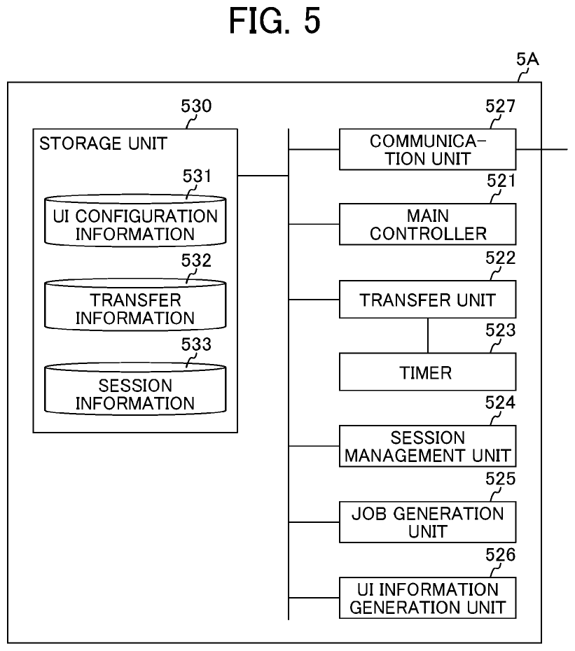

FIG. 5 is a block diagram illustrating a functional configuration of the print server according to the present embodiment.

The print server 5A includes a main controller 521, a transfer unit 522, a timer 523, a session management unit 524, a job generation unit 525, a UI information generation unit 526, a communication unit 527, and a storage unit 530.

The main controller 521, the transfer unit 522, the timer 523, the session management unit 524, the job generation unit 525, and the communication unit 527 are implemented by the CPU 501 reading a program stored in the ROM 502 and executing the program read into the RAM 503. The storage unit 530 is implemented by the RAM 503 and the HD 504.

The main controller 521 controls each unit included in the print server 5A. The main controller 521 gives a command to each unit included in the print server 5A.

The transfer unit 522 redirects an access (page request) to a specific URL from the information processing terminal 5B to another URL as necessary.

When there is an access to the dedicated URL 2 from the information processing terminal 5B and there is no valid temporary URL 3, the transfer unit 522 newly generates a temporary URL 3 and responds to the information processing terminal 5B. “Temporary URL 3 is valid” indicates, for example, that temporary URL 3 generated corresponding to the dedicated URL 2 exists in transfer information 532.

When there is an access to the dedicated URL 2 from the information processing terminal 5B and there is a valid temporary URL 3, the transfer unit 522 reads the temporary URL 3 from the transfer information 532 of the storage unit 530 and responds to the information processing terminal 5B.

When the information processing terminal 5B accesses the temporary URL 3 that is currently invalid, the transfer unit 522 reads the ID selection URL 4 from the transfer information 532 of the storage unit 530 and responds to the information processing terminal 5B. The temporary URL 3 is invalid if, for example, the temporary URL 3 does not exist in the transfer information 532.

The timer 523 counts a time period to indicate the timing for updating or deleting the temporary URL 3.

The session management unit 524 manages a session with the information processing terminal 5B.

The job generation unit 525 generates a print job to be transmitted to the MFP 9.

The UI information generation unit 526 generates information (UI information, for example, an html file) related to the web UI provided to the information processing terminal 5B. When there is an access to the currently valid temporary URL 3 from the information processing terminal 5B, the UI information generation unit 526 reads information for constructing the web UI from the UI configuration information 531 of the storage unit 530, generates UI information, and responds to the information processing terminal 5B.

The communication unit 527 transmits and receives information to and from each device through the access point 6 and the communication network 100.

The storage unit 530 stores UI configuration information 531, transfer information 532, and session information 533.

The UI configuration information 531 is web UI content data provided to the information processing terminal 5B.

The transfer information 532 is information related to the redirect destination URL and includes information on the temporary URL and the ID selection URL. The temporary URL is updated or deleted at the preset timing.

The session information 533 is information related to a session between the information processing terminal 5B and the print server 5A. The session information 533 is associated with terminal identification information for identifying the information processing terminal 5B, an expiration date of the session, and the like for each session ID that is identification information of the session. Information related to a session for which a disconnection request has been received from the information processing terminal 5B or a session whose validity period has expired is deleted.

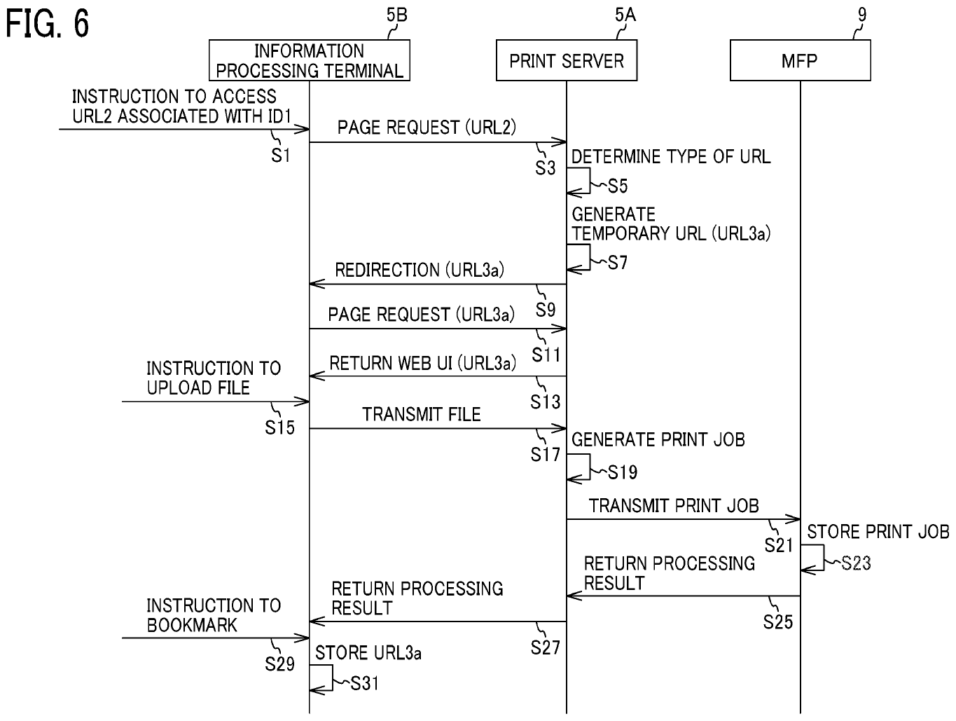

FIG. 6 is a sequence diagram illustrating a basic redirect process executed by the information processing system. In the sequence diagram illustrated in FIG. 6, the MFP 9 is illustrated as an example of the network resource included in the first network environment 101.

In this sequence diagram, an example of a user accessing the first network environment 101 using a guest user ID 1 accesses URL 2 associated with the ID 1 from the information processing terminal 5B and use the MFP 9 through the web UI provided from the print server 5A is described.

This sequence diagram illustrates an example where there is no valid temporary URL 3a corresponding to the dedicated URL 2, and the print server 5A generates and redirects to the temporary URL 3a.

In step S1, the user instructs the information processing terminal 5B to access the dedicated URL 2 associated with the user ID 1.

In step S3, the information processing terminal 5B transmits a page request for the dedicated URL 2 to the print server 5A.

In step S5, the transfer unit 522 of the print server 5A determines a type of URL transmitted from the information processing terminal 5B In this example, since the URL received from the information processing terminal 5B is the dedicated URL 2 and the temporary URL 3a corresponding to the dedicated URL 2 does not exist in the transfer information 532, the process of step S7 is executed.

In step S7, the transfer unit 522 of the print server 5A generates a temporary URL 3a corresponding to the dedicated URL 2 and stores the temporary URL 3a in the transfer information 532.

In step S9, the main controller 521 of the print server 5A returns a temporary URL 3a as a redirect destination URL to the information processing terminal 5B.

In step S11, the information processing terminal 5B transmits a page request for the URL 3a to the print server 5A.

In step S13, the UI information generation unit 526 of the print server 5A reads the content to be displayed as the page of the URL 3a from the UI configuration information 531, generates UI information (html), and responds to the information processing terminal 5B.

When the user uses the MFP 9 for printing an image based on an electronic file, following process is executed.

In step S15, the user instructs the information processing terminal 5B to upload the file to be printed by the MFP 9.

In step S17, the information processing terminal 5B transmits the file to the print server 5A.

In step S19, the job generation unit 525 of the print server 5A generates a print job including an ID and password of login information to the MFP 9. The job generation unit 525 embeds a URL of the web UI (temporary URL 3a) as the ID for identifying the print job and a temporarily generated password as the password in the print job.

In step S21, the job generation unit 525 of the print server 5A transmits the print job to the MFP 9.

In step S23, the MFP 9 stores the received print job in the HD 909.

In step S25, the MFP 9 responds to the print server 5A that the print job has been stored as a processing result.

In step S27, the UI information generation unit 526 of the print server 5A responds to the information processing terminal 5B with the processing result of the print job by the MFP 9. At this time, the UI information generation unit 526 generates UI information including login information to the MFP 9 and causes the information processing terminal 5B to display the UI information.

When the user prints an image of the file transmitted to the print server 5A on the MFP 9, the user needs to log in to the MFP 9 using the provided ID card and instruct the MFP 9 to execute the print job. When the print job is executed, the print job is completed.

If the user instructs the information processing terminal 5B to bookmark the URL of the web UI (step S29), the information processing terminal 5B stores the URL 3a in the HD 504 in the own device (step S31).

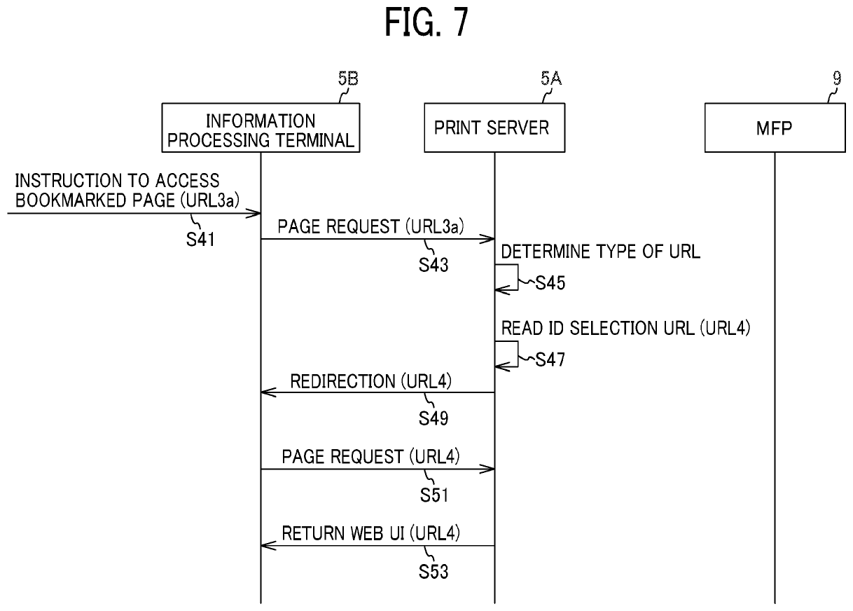

FIG. 7 is a sequence diagram illustrating an example of a process when an invalid temporary URL is accessed.

The case where the user accesses an invalid temporary URL through the information processing terminal 5B is, for example, the case where the temporary URL 3a bookmarked in the processing of steps S29 and S31 described in FIG. 6 is accessed.

In step S41, the user instructs the information processing terminal 5B to access the bookmarked temporary URL 3a.

In step S43, the information processing terminal 5B transmits a page request for the temporary URL 3a to the print server 5A.

In step S45, the transfer unit 522 of the print server 5A determines a type of URL transmitted from the information processing terminal 5B. In the example in FIG. 7, since the URL received from the information processing terminal 5B is the temporary URL 3a indicating the redirect destination and the temporary URL 3a is invalid because the temporary URL 3a does not exist in the transfer information 532, the process of step S47 is executed.

In step S47, the transfer unit 522 of the print server 5A reads an ID selection URL 4 from the transfer information 532.

In step S49, the main controller 521 of the print server 5A returns the ID selection URL 4 as a redirect destination URL to the information processing terminal 5B.

In step S51, the information processing terminal 5B transmits a page request for the ID selection URL 4 to the print server 5A.

In step S53, the UI information generation unit 526 of the print server 5A reads content to be displayed as a page of the ID selection URL 4 from the UI configuration information 531 to generate UI information and responds to the information processing terminal 5B.

As described above, when an invalid temporary URL 3a is accessed, the URL is redirected to another URL (ID selection URL 4), preventing direct access by a bookmark according to the present embodiment.

The process executed by the print server in steps S3 to S9 and steps S43 to S49 is described.

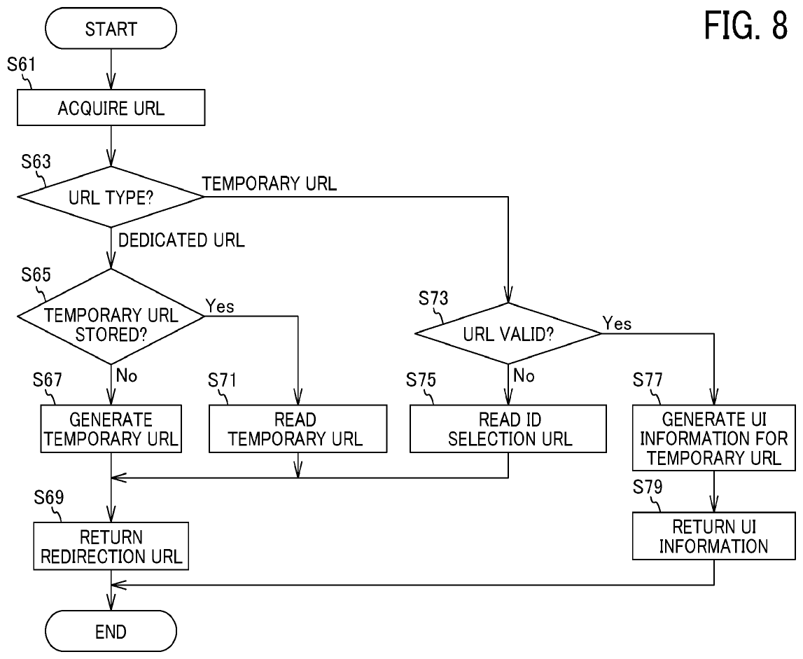

FIG. 8 is a flowchart illustrating an example of a series of processes executed by the print server related to URL determination.

Step S61 corresponds to steps S3 and S43, and steps S63, S65, and S73 correspond to steps S5 and S45. Step S67 corresponds to step S7, and step S75 corresponds to step S47. Step S69 corresponds to steps S9 and S49.

In step S61, the transfer unit 522 acquires the URL of the page requested from the information processing terminal 5B.

In step S63, the transfer unit 522 determines the type of the acquired URL, that is, whether the acquired URL is a dedicated URL or a temporary URL. When the acquired URL is a dedicated URL, process from step S65 is executed. When the acquired URL is a temporary URL, process from step S73 is executed.

In step S65, the transfer unit 522 determines whether a temporary URL corresponding to the dedicated URL exists in the transfer information 532 of the storage unit 530. When the temporary URL exists, the process from step S67 is performed, and when the temporary URL does not exist, the process from step S71 is performed.

In step S67, the transfer unit 522 generates a temporary URL corresponding to the dedicated URL and stores the temporary URL in the transfer information 532 of the storage unit 530.

In step S69, the transfer unit 522 responds to the information processing terminal 5B with the generated temporary URL.

In step S71, the transfer unit 522 reads the temporary URL corresponding to the dedicated URL from the transfer information 532 in the storage unit 530. In step S69, the transfer unit 522 responds to the information processing terminal 5B with the read temporary URL.

In step S73, the transfer unit 522 determines whether the acquired temporary URL is currently valid. When the temporary URL is valid, the process from step S77 is executed, and when the temporary URL is invalid, the process from S75 is executed.

In step S75, the transfer unit 522 reads the ID selection URL from the transfer information 532 in the storage unit 530. In step S69, the transfer unit 522 responds to the information processing terminal 5B with the read ID selection URL.

In step S77, the UI information generation unit 526 reads the content to be displayed as the temporary URL page from the UI configuration information 531 in the storage unit 530 and generates UI information.

In step S79, the UI information generation unit 526 returns the generated UI information to the information processing terminal 5B.

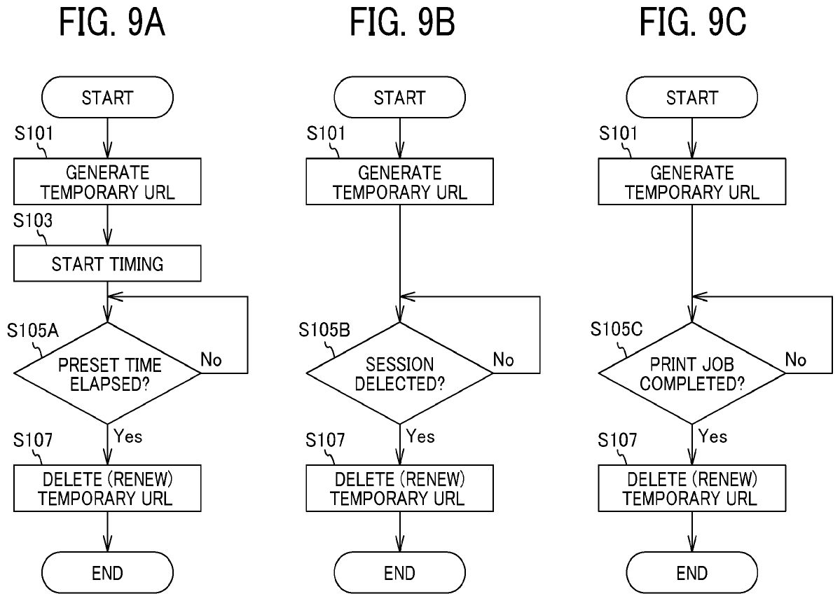

FIGS. 9A to 9C are flowcharts illustrating an example of a process of deleting or updating the temporary URL. Note that the same processing in each flowchart is denoted by the same step number, and the description thereof is omitted as appropriate.

FIG. 9A illustrates an example of a process of invalidating the temporary URL by deleting (or updating) after preset time has elapsed.

In step S101, the transfer unit 522 generates the temporary URL 3.

In step S103, the timer 523 starts counting time.

In step S105A, the timer 523 checks whether or not the preset time has elapsed. When the preset time has not elapsed (No), the timer 523 continues to count time. When the preset time has elapsed (Yes), the process of step S107 is executed.

In step S107, the transfer unit 522 deletes (or updates) the temporary URL 3.

Instead of using the counted time by the timer 523, a time limit may be designated for each temporary URL 3. To designate the time limit for the temporary URL 3, a method of managing the time limit of the key embedded in the temporary URL 3 in a database, a method of using a value indicating the time limit derived using a hash function as the key, and the like may be considered.

FIG. 9B illustrates an example of invalidating a temporary URL by deleting (or updating) when a session through the web UI is deleted.

First, step S101 is executed. In step S105B, the session management unit 524 confirms whether or not the session between the print server 5A and the information processing terminal 5B performed through the web UI has been deleted. When the session has not been deleted (No), counting of time is continued. When the session has been deleted (Yes), the process of step S107 is executed.

In this way, the temporary URL can be invalidated by using deletion of the session as a trigger.

FIG. 9C illustrates an example of invalidating a temporary URL by deleting (or updating) when a print job is completed.

First, step S101 is executed. In step S105C, the main controller 521 confirms whether or not a notification indicating that the job processing (print processing) has been completed is received from the MFP 9. When the notification is received (Yes), the process of step S107 is executed.

In this way, the temporary URL can be invalidated by using completion of the print job as a trigger.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

According to embodiments of the present disclosure, the dedicated URL associated with the guest user ID on a one-to-one basis is an empty page with no substance. According to embodiments of the present disclosure, the URL associated with the user ID and indicating an actual page is the temporary URL. According to embodiments of the present disclosure, unintended account reuse or unauthorized use can be prevented.

According to embodiments of the present disclosure, the print server 5A redirects to another URL as necessary when there is an access (page request) to a specific URL from the information processing terminal 5B, but the print server 5A may execute forward (transfer) processing. In this case, when there is a page request to the dedicated URL 2, the print server 5A makes a transition to the temporary URL 3 and responds to the information processing terminal 5B with the UI information of the temporary URL 3.

The information processing apparatus (print server 5A) according to embodiments of the present disclosure includes the transfer unit 522 that responds with temporarily usable third identification information (URL 3) indicating a transfer destination of the request, in response to a request (page request) using unique second identification information (dedicated URL 2) associated one-to-one with the first identification information (user ID 1) identifying the user (guest user) of the resource (MFP 9).

The second identification information functions as an entry point to a web page indicated by the third identification information. The web page indicated by the third identification information is, for example, a web UI that provides a function for generating a job to be processed by the resource.

The third identification information may be information generated when a request is received, or information generated in advance and stored in the storage unit 530 and read from the storage unit when the request is received.

The request transfer method may be redirect or forward. In the case of redirection, the third identification information is information (URL 3) for identifying a web page (web UI). In the case of forward, the third identification information is the content of the web UI (UI information, html) indicated by the URL 3.

According to embodiments of the present disclosure, reuse or unauthorized use of the first identification information can be prevented. That is, since the request is transferred to the third identification information, reuse or unauthorized use of the first identification information and the fixed second identification information associated with the first identification information can be prevented. In addition, since the third identification information is temporarily used information, it is possible to prevent reuse or unauthorized use of the third identification information associated with the first identification information.

In the information processing apparatus (print server 5A) according to embodiments of the present disclosure, the transfer unit 522 invalidates the third identification information (URL 3) at the preset timing.

Invalidation includes deletion of the third identification information and update of the third identification information (update from URL 3a to URL 3b).

The preset timing is set to a timing when use of the resource by the guest user is completed, when use of the web page indicated by the third identification information is completed, or the like, and includes, for example, when the resource (MFP 9) completes the processing of the print job created on the web page (web UI) indicated by the third identification information, when the preset time has elapsed since the processing of the print job was completed, or when the session between the information processing terminal 5B and the information processing apparatus is disconnected. Also, examples of the preset timing include when the preset time has elapsed since the third identification information was created, and when preset time of day has passed.

The guest user may reuse the third identification information by storing the third identification information used in the past in the information processing terminal 5B owned by the guest user. According to embodiments of the present disclosure, since the third identification information is invalidated at the preset timing, a request (page request) using the third identification information that has been valid in the past can be blocked.

In the information processing apparatus (print server 5A) according to embodiments of the present disclosure, the transfer unit 522 returns the fourth identification information (ID selection URL 4), which is information for displaying a screen for selecting the first identification information (user ID 1) or the second identification information (dedicated URL 2), in response to a request using invalid third identification information (URL 3).

The guest user may reuse the invalidated third identification information by storing the third identification information used in the past in the information processing terminal 5B owned by the guest user. According to embodiments of the present disclosure, when a request using invalid third identification information is transmitted, it is possible to follow up so that a request using valid third identification information is transmitted through the web page indicated by the fourth identification information.

In the information processing apparatus (print server 5A) according to embodiments of the present disclosure, the third identification information (URL 3) is generated using a hash value.

The third identification information is desirably a unique value that cannot be easily estimated. When the third identification information is generated using the hash value as in embodiments of the present disclosure, it becomes difficult for a third party different from the regular guest user to guess the third identification information. Therefore, a request (page request) using valid third identification information by a person other than the regular guest user can be blocked, and the security of data held by the regular guest user can be improved.

In the information processing apparatus (print server 5A) according to embodiments of the present disclosure, when the preset time has elapsed from the request using the second identification information (dedicated URL 2), the transfer unit 522 invalidate third identification information (URL 3). The preset time is set to a time for the guest user to complete the use of the resource, complete use of the web page indicated by the third identification information, or the like.

According to embodiments of the present disclosure, since the third identification information is invalidated when the preset time has elapsed, a request (page request) using the third identification information that has been valid in the past can be blocked.

In the information processing apparatus (print server 5A) according to embodiments of the present disclosure, the transfer unit 522 invalidates the third identification information (URL 3) when the preset time of day comes. The preset time is set to a time when use of the resource by the guest user is deemed to be completed, when use of the web page indicated by the third identification information is deemed to be completed, or the like.

According to embodiments of the present disclosure, since the third identification information is invalidated at the preset time, a request (page request) using the third identification information that has been valid in the past can be blocked.

In the information processing apparatus (print server 5A) according to embodiments of the present disclosure, the transfer unit 522 invalidates the third identification information (URL 3) when the preset event occurs.

Examples of the preset events may be when the resource (MFP 9) completes the processing of the print job created on the web page indicated by the third identification information, when the preset time has elapsed since the completion of the processing of the print job, or when the session between the information processing terminal 5B and the information processing apparatus is disconnected.

When the event is set to an event that occurs when the use of the resource (MFP 9) by the guest user is completed, an event that occurs when the use of the web page indicated by the third identification information is completed, or the like, the third identification information can substantially be effective for one time provided that the third identification information is a unique value. Therefore, the reuse and unauthorized use of the third identification information can be prevented, and the security of data held by the guest user can be improved.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus comprising:
circuitry configured to;
receive a request using unique second identification information that is associated one-to-one with first identification information for identifying a user of a resource; and
return third identification information to be used temporarily, indicating a transfer destination of the request, in response to the request.

2. The information processing apparatus of claim 1, wherein
the circuitry is further configured to:
invalidate the third identification information at a preset timing.

3. The information processing apparatus of claim 1, wherein
the circuitry is further configured to:
return fourth identification information for displaying a screen for selecting the second identification information, in response to a request using an invalid third identification information.

4. The information processing apparatus of claim 1, wherein
the third identification information is generated using a hash value.

5. The information processing apparatus of claim 2, wherein
the preset timing is when a preset time has elapsed from a time when the request using the second identification information has received.

6. The information processing apparatus of claim 2, wherein
the preset timing is when a current time reaches a preset time.

7. The information processing apparatus of claim 1, wherein
the preset timing is when a preset event occurs.
